(19) United States
(12) Patent Application Publication
(10) Pub. No.: US 2004/0143536 A1
(43) Pub. Date: Jul. 22, 2004

(54) Method and system for trading a foreign exchange swap certificate

(75) Inventor: Rainer Haberle, Giffers (CH)

Correspondence Address: NIXON PEABODY, LLP, 401 9TH STREET, NW, SUITE 900, WASINGTON, DC, 20004-2128, US

(73) Assignee: UBS AG, Stamford, CT (US)

(21) Appl. No.: 10/345,926

(22) Filed: Jan. 17, 2003

(51) Int. Cl. G06F 17/60

(52) U.S. Cl. 705/37

(57) ABSTRACT

A novel method, system and computer readable medium are provided which effectively executes underlying transactions of an inventive financial instrument having a foreign exchange swap component and an investment component. The swap component includes a spot transaction and a forward transaction while the short term investment component includes investing the money resulting from the spot transaction in an investment, such as in a money market or bond investment. Three different financial instruments/certificates are provided to offer different returns based on different expectations of interest rates and, in particular, of changes in the differential between the interest rates of two selected currencies.

### BACKGROUND OF THE INVENTION

1. Technical Field

This invention relates to a method, system and computer readable medium for trading a particular inventive certificate packaged as a tradable security and comprised of a foreign exchange swap component and a short term investment component.

2. Description of Related Art

Financial investment providers continue to develop a variety of investment products providing a range of investment returns, risk, and tax efficiencies to their clients. For example, money market investments offer lower risks with lower returns while stocks and commodities offer the potential for relatively higher returns but with higher risk. These investment products are typically offered by dealers and brokers to their clients in exchange for a fee.

Money market related investments include direct money market investments, money market fiduciaries, money market funds, commercial papers, T-Bills and floating rate notes. Money market investments offer only an exposure to the yield curve of the currency in which it is denominated and are relatively risk-free if held until maturity. Interest rate related instruments, such as interest rate swaps, forward rate agreements, and futures on money market rates, do not offer an investment in a liquid/short term asset, but only an exposure to interest rates which is absorbed, in terms of risk, by a credit line with a bank, or, for a future, by the margin deposited with the exchange.

The foreign exchange market is an international market wherein large banks and security dealers maintain trading rooms for electronically posting their bid and ask prices for currencies. Rates are offered for both the “spot market” for exchanging one currency with another for immediate delivery and the “forward market” for exchanging one currency for another at a future date. The volatility of foreign exchange rates over time creates investment risk as well as opportunities for speculative gain. As a result, foreign exchange trading within the financial community, for either hedging or for profit based on proprietary forecasts of future rate changes, has grown dramatically over the past several decades. Another foreign exchange related transaction is a securitized foreign exchange forward which can be viewed as leveraged. Other conventional products include an OTC forward (which is traded against a credit line) or futures contracts which require a margin deposit.

Instruments relating to both foreign exchange rates and interest rates include currency protected swaps and cross currency swaps. These instruments involve only an exchange of interest of different currency, no exchange or investment of principal and no locking in of forward foreign exchange rates to capture the interest differential.

One particular foreign exchange transaction is a foreign exchange swap which includes a spot transaction and a forward transaction. Upon the execution of the swap transaction, an investor agrees to exchange an amount of one currency for another at a specified spot rate, for immediate delivery (spot transaction) while also agreeing to reverse the transaction by exchanging the currencies at a future date at an agreed forward rate (forward transaction). Foreign exchange swaps are typically used in relation to hedging transactions and cash flows or underlyings in foreign currencies.

U.S. Pat. No. 6,304,858 discloses a method, system and computer program product for trading interest rate swaps wherein a standardized contract is traded through an exchange that guarantees payment to the buyer of any amount owed to the buyer from the seller and vice versa. By making swaps suitable for exchange based trading, the system reduces counterparty risk issues and provides a new segment of investors access to previously limited to large, well rated participants. However, the underlying product is only the interest rate swap, i.e. a contract, and therefore does not include an underlying investment. Also, the yield curve of this contract is based on a single currency.

International Patent Publication WO 02/46982 discloses a system and method for managing a financial transaction including a note which is exchangeable into exchange traded products, i.e. stocks or bonds, related to a benchmark index. The underlying instrument or note however does not include a combination of a foreign exchange swap and a short term investment, nor does it offer an exposure linked to the yield curves of two currencies.

International Patent Publication WO 02/31716 is noted for disclosing a method for hedging a currency risk. However, this reference is not directed to an investment product and therefore does not suggest a financial instrument having a foreign exchange swap component and a short term investment component.

### SUMMARY OF THE INVENTION

Therefore, one object of the present invention is to provide a method and system for efficiently and effectively trading one or more novel foreign exchange swap certificates providing a variety of return profiles.

It is another object of the present invention to provide a method and system for offering and executing the purchase of a financial instrument having an investment component and a foreign exchange swap component.

It is also an object of the present invention to provide a method and system for offering and executing the purchase of a financial instrument having a ‘short term’ investment component and a foreign exchange swap component, where the short term investment is an investment in a debt security for a period less than a certificate maturity period.

It is yet another object of the present invention to provide a novel method and computer implemented system for a novel foreign exchange swap certificate offering low risk, significant return and tax efficiencies.

Yet another object of the present invention is to provide a novel method and system for offering and executing a novel foreign exchange swap certificate offering a return in the form of interest income and capital gain.

Still another object of the present invention is to provide a novel method and system for offering and executing a novel foreign exchange swap certificate capable of minimizing interest income while maximizing capital gains thereby optimizing tax efficiencies in certain jurisdictions.

A further object of the present invention is to provide a novel method and system for offering and executing a novel foreign exchange swap certificate having underlying foreign exchange swap and short term investment transactions packaged as a single security for selection by a client so that underlying transactions of the certificate remain “invisible” to the client thereby creating a simple, efficient investment for the client.

A still further object of the present invention is to provide a novel method and system for offering a novel foreign exchange swap certificate having multiple underlying transactions structured as a single security advantageously resulting in the investor having only a single exposure which is achieved by a single transaction.

Yet another object is to provide a novel method and system for offering a novel foreign exchange swap certificate having multiple underlying transactions packaged as a security thereby maintaining a liquid secondary market with all client related cash flows occurring in one currency.

Still another object of the present invention is to provide a novel method and system for offering and executing a foreign exchange swap certificate for clients wishing to combine short term availability of funds (funds available substantially immediately, e.g., two days after trading) with a short term yield curve.

Yet another object of the present invention is to provide a novel method and system for offering and executing a plurality of novel foreign exchange swap certificates offering different return profiles and selectable based on a purchaser's or advisor's view of future relative changes in the interest rates of two currencies.

It is yet another object of the present invention to provide a novel method and system for offering and executing a novel foreign exchange certificate designed to provide positive returns based on the view of an increasing interest rate differential between two currencies, and a separate novel foreign exchange swap certificate designed to provide a positive return based on the view of a decreasing interest rate differential between the two currencies.

Still another object of the present invention is to provide a novel method and system for trading a foreign exchange swap certificate having numerous underlying foreign exchange and short term investment transactions while permitting the certificate to be simply and easily distributed and executed substantially electronically.

These and other objects of the present invention are achieved by providing a method for executing a financial instrument having a foreign exchange swap component and a short term investment component, comprising executing the foreign exchange swap component including conducting a spot transaction by selling a principal amount in a first currency for a second currency at a spot rate, and determining a forward transaction for exchanging the second currency for the first currency at a first forward rate based on a future date. The method includes the steps of executing a short term investment component including investing the principal amount in the second currency resulting from the spot transaction in a short term investment and executing the forward transaction.

The method is advantageously applied to a financial instrument or certificate which preferably provides a positive total return over a maturity period of the instrument upon a decrease in an interest rate differential between an interest rate of the first currency and an interest rate of the second currency, and/or a financial instrument providing a positive total return over a maturity period of the instrument upon an increase in an interest rate differential between a money market interest rate of the first currency and a money market interest rate of the second currency. Note that the interest rate of the first and second currencies may be a money market interest rate, a swap interest rate, bond yield interest rate, or any other rate, depending on the desired length (short, medium, or long) and risk. It should be appreciated that although the currency interest rate, discussed herein, may be based on virtually any instrument, the application will mainly discuss money market interest rates for ease of discussion.

Three preferable financial instruments/certificates are described in detail in accordance with the present invention. These are the so-called “Bear instruments/certificates”, “Leveraged Bear instruments/certificates”, and “Bull instruments/certificates”. It should be appreciated that although the assignee of this invention may, in the future, offer instruments of the same name, those financial products are not necessarily the same as the instruments described herein. Further, note that the terms “certificate” and “instrument” may be used interchangeably herein.

For the Bear instrument, the forward transaction includes determining the first forward rate based on interest rates corresponding to an instrument maturity period, and purchasing an amount of the first currency at an end of the instrument maturity period corresponding to an investment in the second currency at the first forward rate. The investment includes an investment maturity period shorter than the instrument maturity period. The method may also include the step of investing the second currency in an investment including the steps of determining an investment interest rate associated with the investment maturity period, calculating an investment interest amount earned on the principal amount of the investment during the investment maturity period based on the investment interest rate, determining a foreign exchange spot rate at the end of the investment maturity period and exchanging the investment interest in the second currency for the first currency based on the foreign exchange spot rate. The method may further include the step of repeating the investment of the principal amount in the second currency in a series of investments until the end of the instrument maturity period. It is important to note that the investment may be a short, medium, or long term period, so long as the investment includes an investment maturity period shorter than the instrument maturity period. For ease of discussion, the investment discussed herein for all embodiments will be short term.

With respect to the Leveraged Bear instrument, the forward transaction includes determining the first forward rate based on foreign exchange spot rates and interest rates, or by directly accessing foreign exchange forward rates provided by a market source, corresponding to a forward maturity period equal to multiple instrument maturity periods and purchasing the principal amount of the first currency against the second currency at an end of a forward maturity period at the first forward rate. The investment (e.g., short term) includes an investment maturity period less than the instrument maturity period and the step of investing the second currency in a short term investment includes the steps of determining an investment interest rate associated with the investment maturity period, calculating an investment interest amount earned on the principal amount of the investment during the investment maturity period based on the investment interest rate, determining a foreign exchange spot rate at the end of the investment maturity period, and exchanging the investment interest in said second currency for the first currency based on the foreign exchange spot rate. The method also includes the step of repeating the investment of the principal amount in the second currency in investments until the end of the instrument maturity period, determining a maturity spot rate at the end of the instrument maturity period, and purchasing the principal amount in the first currency against said second currency at the maturity spot rate. The method further includes the steps of determining a second forward rate upon maturity of the instrument based on a forward maturity date equal to an end of said forward maturity period for selling the principal amount in the first currency for the second currency, and selling the principal amount in the first currency for the second currency at the second forward rate. The method may also include the steps of calculating one of profits and losses in the second currency upon executing the forward transaction and discounting one of the profits and the losses to the instrument maturity date.

With respect to the Bull instrument, the investment (e.g., short term) includes an investment maturity period equal to the instrument maturity period. The forward transaction includes determining the first forward rate based on interest rates corresponding to a forward maturity period less than the instrument maturity period and purchasing the principal amount of the first currency against the investment in the second currency at an end of the forward maturity period. The method further includes the steps of determining a maturity spot rate at an end of the forward maturity period, selling the purchased principal amount in the first currency for the second currency at the maturity spot rate, determining another forward rate for another forward maturity period, and purchasing the principal amount in the first currency against the second currency at an end of the another forward maturity period. The method also includes continuing to repeat the spot and forward transactions, until the end of the instrument maturity period. The method also preferably includes the step of determining a foreign exchange forward rate based on the instrument maturity period and forward selling an interest earned on the investment in the second currency at an end of the instrument maturity period.

The above Bear, Leveraged Bear, and Bull instruments may include the offering of one or more of the certificates by an issuer to a client and the execution of the steps of the method in response to a client's request to purchase one or more of the certificates. In another embodiment of the invention, the method steps are performed by a computer implemented system having various units for executing the steps. The steps may be in the form of executable instructions on a computer readable medium.

Many of the objects of the present invention are also achieved, at least in part, by providing the inventive financial instruments/certificates of the present invention, which each represent a single security, with plural components and having an instrument maturity period. Each instrument comprises: at least one foreign exchange swap component having a principal amount in a first currency, a spot transaction amount in a second currency resulting from a spot transaction of the first currency at a spot rate, and a forward transaction amount determined by an exchange of the second currency for the first currency at a first forward rate based on a future date; and at least one investment component having an initial investment amount, an interest rate, and an investment maturity period, wherein the initial investment amount is the spot transaction amount in the second currency resulting from the spot transaction.

The Bear and Leveraged Bear instruments preferably provide a positive total return over the instrument maturity period upon a decrease in an interest rate differential between a money market interest rate of the first currency and a money market interest rate of the second currency. The Bull instrument provides a positive total return over the instrument maturity period upon a decrease in an interest rate differential between a money market interest rate of the first currency and a money market interest rate of the second currency.

### BRIEF DESCRIPTION OF THE DRAWINGS

FIG. 1 is a schematic diagram of the computer system of the present invention for offering and executing one or more foreign exchange swap certificates of the present invention;

FIG. 2 is a flow diagram illustrating the primary steps of the method of the present invention for providing and executing one or more foreign exchange swap certificates;

FIG. 3 is a flow diagram of the method of the present invention showing the steps for executing the Bear certificate of the present invention;

FIG. 4 is a graph showing the interest rate yield and yield differential over time for two example currencies as applied to the Bear certificate;

FIG. 5 is a flow diagram of the method of the present invention showing the steps for executing the Leveraged Bear certificate of the present invention;

FIG. 6 is a graph showing the interest rate yield and yield differential over time for two example currencies as applied to the Leveraged Bear certificate;

FIG. 7 is a flow diagram of the method of the present invention showing the steps for executing the Bull certificate of the present invention;

FIG. 8 is a graph showing the interest rate yield and yield differential over time for two example currencies as applied to the Bull certificate; and

FIG. 9 is a chart identifying the particular cash flows, expectation and risk associated with the Bear, Bull and Leveraged Bear certificates of the present invention using the currencies of the examples graphically shown in FIGS. 4, 6 and 8.

### DETAILED DESCRIPTION OF THE PREFERRED EMBODIMENT

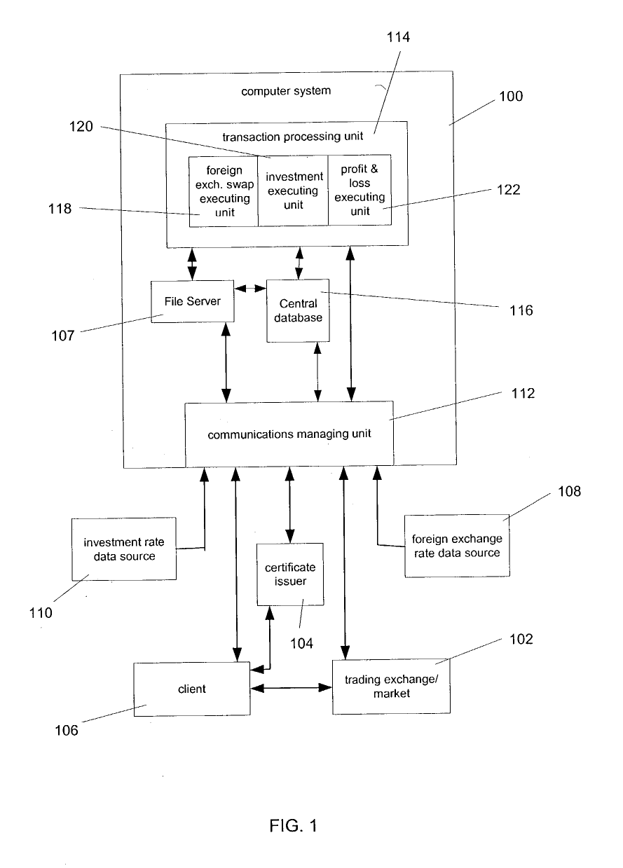

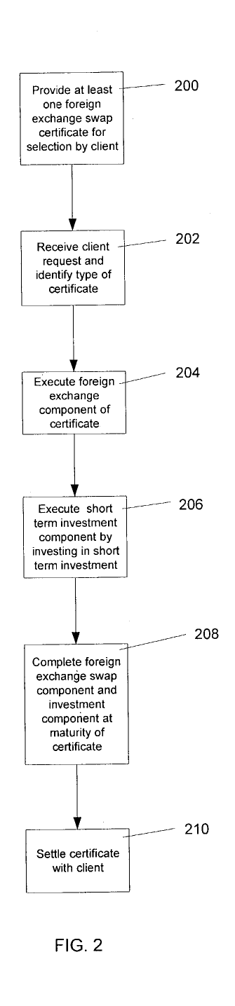

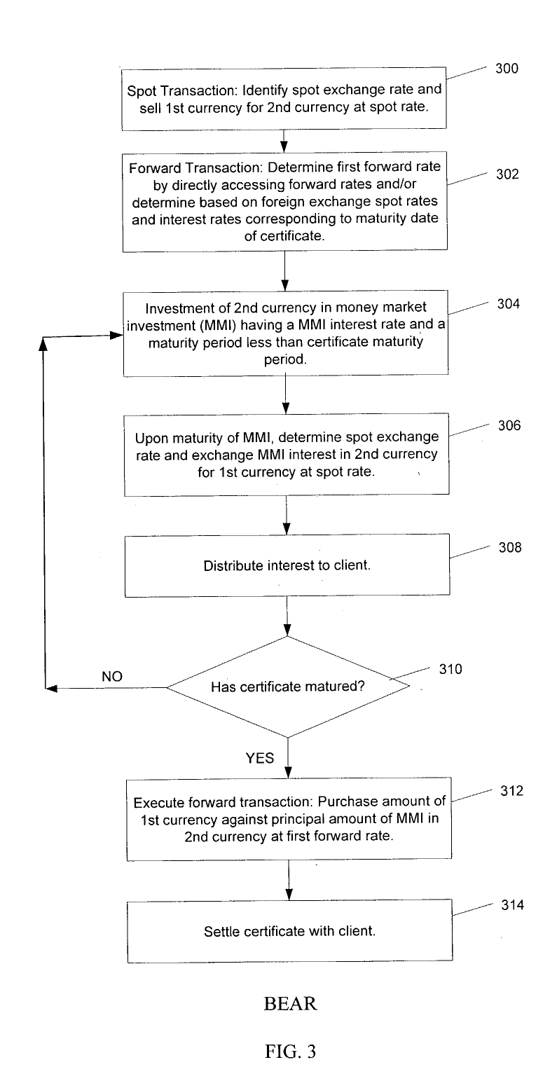

Referring now to the drawings, and more particularly to FIGS. 1 and 2 thereof, the present invention provides a system and method for offering and executing the purchase of, or trading of, one or more novel securities in the form of financial instruments or certificates, providing a variety of return profiles. Each novel certificate, generally referred to herein as a foreign exchange swap certificate, is a tradable item packaged as a security comprised of the combination of a foreign exchange swap transaction component and an interest bearing investment component. As stated above, although the investment component may be of a short, medium, or long term, for ease of discussion only a short term investment, and specifically a money market investment, will generally be described. There are three varieties of the inventive certificate—the “Bear” variety, the “Leveraged Bear” variety and the “Bull” variety —which are described in greater detail below with reference to FIGS. 3-8.

Referring to FIG. 1, one example of the system of the present invention is shown which includes a computer system 100 within which portions of the present invention reside in the form of computer readable storage medium having executable instructions, and computer architecture as discussed hereinbelow. The money market foreign exchange swap certificates may be provided by an issuer 104 and purchased by a client 106 in several ways. For example, in communication with the computer system 100 is a market 102 for exchange traded items through which the certificates may be traded, such as the Swiss Exchange. The money market swap certificate of the present invention may also be provided by the issuer directly to a client. The certificate may be offered by the issuer on the issuer's website, or a website provided by a financial network such as Bloomberg Financial or Reuters. Detailed information regarding the certificates is preferably provided electronically. For example, computer system 100 may include a file server 107 containing electronically displayable files provided to a website for consideration by client 104 or directly to client 104 or a client's agent by, for example, electronic mail. The files preferably include a term sheet containing the terms and conditions of the certificate purchase transaction including maturity periods, type of money market investment, rate source, current indicative rates, etc. Client 106 may utilize conventional e-banking systems to purchase the certificate from issuer 104 or may use some other form of communication, such as telephone or facsimile, to communicate the client's desire to purchase the certificate from the issuer or a broker. The issuer terminal 104 includes a display screen and data input devices, such as a keyboard and mouse, and preferably is connected to output devices, such as a printer for printing various reports. Likewise, the client terminal 106 includes similar devices. The computer readable storage medium and computer architecture of computer system 100 may reside on a single computer terminal or workstation 104 or, preferably, reside on a remote server of a network to which the issuer terminal 104 is connected as shown in FIG. 1. For example, the network may be a local area network dedicated to a single office of an enterprise or a wide area network serving various offices of one or more enterprises.

Computer system 100 is also connected via a communication link to an external foreign exchange rate data source 108 for providing the computer system 100 with real-time exchange rate data, such as the spot or forward rates used in the transactions described herein. Foreign exchange rate data source 108 may be any source of rates suitable for spot and other foreign exchange related rates. Also, exchange rate data source 108 may be a different source depending on the type of rate desired. Preferably, as used herein, the spot rate is the mid-rate published on Reuters for the particular currency reference rates, the LIMEAN (London Interbank Mean Rate) rates are used for interest rates for a period of one year or less, and ISDA (International Swaps and Derivatives Association) benchmark swaps rates are used for interest rates for periods more of than one year. In addition, an investment rate data source 110 is connected to computer system 100 via a communication link for providing current investment interest rates for different short term investments in various currencies and for various time periods.

The various communications links between market 102, client 106, data sources 108 and 110 and computer system 100, including issuer 104, can be established over any data communications network capable of effectively transmitting the data, such as a worldwide interconnected network of computers (e.g. the Internet), a public switch telephone network, or any other suitable data communication pathway. Also, the information/data may be transmitted using a variety of data communication paths such as phone lines, wireless transmissions and/or digital data lines.

Computer system 100 also includes a communications managing unit/system 112 for managing communications and interactions between computer system 100, market 102, client terminal 106, investment rate data source 110 and foreign exchange rate data source 108. The communications managing unit 112 includes a client interface through which the client information is output and received.

Computer system 100 also includes a transaction processing unit 114 for executing the various underlying transactions of each certificate as discussed hereinbelow. Transaction processing unit 114 communicates with the foreign exchange rate data source 108 via an exchange rate interface in the communications managing unit 112 for ensuring compatible communications and data transfer. Likewise, transaction processing unit 114 receives information from investment rate data source 110 via a money market interface for likewise ensuring compatible effective data transfer between source 110 and unit 114.

Computer system 100 also includes a central database for storing all information relating to the certificates being offered and all transactions relating to each purchased certificate. Preferably, central database 116 receives information from, and may be accessed by, all the components of computer system 100. The information stored in central database 120 may include, for example, the type of certificate purchased, the purchase price, the spot rate, the forward rates and related interest rates, the type of short term investment for a particular transaction, any profits or losses, the client's contact information, various maturity periods for the underlying transactions, the type of certificate (Bear, Leveraged Bear and/or Bull) etc.

The client 106 may be any individual, group or institution that wishes to purchase the foreign exchange swap certificate of the present invention. For example, a client may be an individual investor, such as a swap trader, speculator, money market investor or yield curve trader, a financial institution, such as a bank acting as an agent for its own clients, or any other entity, such as a corporation or association, or a broker acting on behalf of any of these individuals or entities.

Transaction processing unit 114 includes software, including suitable application software, residing in a computer readable storage medium in the form of encoded executable instructions, for operating computer system 100 and processing the underlying transactions associated with the variety of foreign exchange swap certificates described hereinbelow. Specifically, transaction processing unit 114 at least includes a swap execution unit or foreign exchange swap executing unit 118 for executing the underlying transactions relating to the foreign exchange swap component of the foreign exchange swap certificate of the present invention. For example, after the purchase of a foreign exchange swap certificate by client 106 and an appropriate confirmed transfer of payment to the issuer, swap executing unit 118 conducts a spot transaction by selling a principal amount of the certificate in a first currency, e.g. the client's reference currency, for a second currency at a spot rate, and determines a forward transaction for exchanging the second currency for the first currency at a first forward rate on a future date. Swap executing unit 118 accesses the spot interest rate and interest rates required to calculate the first forward rate, from foreign exchange rate data source 108 or accesses the relevant forward rates directly. Swap executing unit 118 also calculates the first forward rate as discussed more fully hereinbelow, or accesses a first forward rate from a market source, for each of the types of certificates. Likewise, swap executing unit 118 executes the forward transaction and other foreign exchange transactions, for example, for the Leveraged Bear certificate, as required to complete the original foreign exchange swap component of the particular certificate.

Computer system 100 also includes an investment execution unit 120 for executing the steps required in the underlying transactions related to, e.g., the short term investment of the particular certificates as set forth in FIGS. 3-8, which includes processing the investment of the short term investment component of the foreign exchange swap certificate in market 102. For example, investment executing unit 120 functions to calculate the investment interest amount earned on the principal of the investment (e.g., short term) during the agreed upon investment maturity period associated with the purchased certificate. Transaction processing unit 114 further includes a profit and loss executing unit 122 which functions to calculate any profits or losses in the underlying transactions discussed hereinbelow and, for example, discount the profits or losses to the maturity of the certificate as required, for example, with the Leveraged Bear certificate. These and other functions of swap executing unit 118, investment executing unit 120 and profit and loss executing unit 122 will become apparent from the discussion below relative to the underlying transactions associated with the three types of foreign exchange swaps certificates of the present invention.

The rates, time periods, amounts, currencies, etc., discussed herein can be of any type, duration and amount unless otherwise explicitly limited independent of the examples provided herein. Also, the present system can utilize various devices, such as personal computers, servers, workstations, PDA's, thin clients and the like. For example, the client terminal can be a handheld device such as a mobile phone or a PDA. Various channels for communication can be used. Further, the various functions can be integrated in one device. The disclosed functional units, such as foreign exchange swap executing unit 118, investment executing unit 120 and profit and loss executing unit 122, are segregated by function for clarity. However, the various functions can be combined or segregated as hardware and/or software modules in any manner. The various functions can be useful separately or in combination.

Referring to FIG. 2, a general representation of the preferred method of the present invention is illustrated in the form of a flow diagram starting with step 200 in which the issuer 104 provides at least one foreign exchange swap certificate for selection by a client. Next, in step 202, computer system 100 receives the client's request and identifies the type of certificate, i.e. Bear, Leveraged Bear and/or Bull certificate, requested via communications managing unit 112. Once payment by the client has been confirmed, foreign exchange swap executing unit 118 is initiated to execute the foreign exchange swap component of the particular certificate in step 204. Next, in step 206, investment executing unit 120 executes the short term investment component by investing the principal amount in the second currency in the short term investment of the certificate. The short term investment may be any short-term debt security, such as banker's acceptances, commercial paper, repos, negotiable certificates of deposit, deposits and Treasury Bills. The maturity period of the money market investment may be any relatively short term period, such as six months, one year, two years, etc, but is preferably a period of one year or less. For example, a Bull certificate with a maturity of two years would require a money market investment having a maturity period of two years. In step 208, upon maturity of the foreign exchange swap certificate, the foreign exchange swap component and the short term investment component of the selected certificate are completed. The details of the underlying transactions associated with each of the steps 200-208 with the respect to the particular type of foreign exchange swap certificate of the present invention will be discussed hereinbelow. Once the components are completed, the entire transaction is then settled with the client in step 210 by returning the principal amount of the certificate plus any profit or minus any loss experienced at the maturity of the certificate as discussed hereinbelow.

In the preferred embodiment of the system and method of the present invention, three different foreign exchange swap certificates are provided for selection by a client. Specifically, the foreign exchange swap certificates are referred to herein as the Bear certificate, the Leveraged Bear certificate and the Bull certificate. Each of these certificates includes a foreign exchange swap component and an investment component (e.g., short term) combined in the form of a single security/certificate. With each of the foreign exchange swap certificates, the principal amount is not exposed to foreign exchange risk with respect to changes in the foreign exchange rates. The principal amount is defined as that amount of the first currency exchanged into the second currency in the initial spot transaction of the swap component of each certificate. The resulting amount of second currency may be referred to as a spot transaction amount which is then invested in the short term investment to form the initial investment amount. The swap component also includes a forward transaction exchanging the second currency for the first currency at a forward rate resulting in a forward transaction amount in the first currency.

In a preferred embodiment of the invention, each of the foreign exchange swap certificates are designed to create a total return consisting of short term investment interest income and a capital gain through the foreign exchange swap component thereby providing certain tax efficiencies in certain jurisdictions. The economic benefit due to the interest rate differential of the swap component creates a capital gain which may not be taxable or taxed at a reduced rate. The laws and rulings of a particular jurisdiction will of course determine, in particular, whether the economic capital gain is also considered a capital gain for tax purposes and whether a capital gain is taxed less heavily than interest income. In some jurisdictions the product might simply be regarded as a derivative instrument benefiting from a more advantageous tax treatment than a short term investment. Assuming that the capital gains also remain capital gains for tax purposes, the tax efficiency depends directly on the chosen currency pair and the yield curves of that currency pair.

Each certificate fundamentally offers an investment in a short term note/certificate with the amount of repayment to the client dependent on the changes in the interest rates, and thus the yield curves, of the two currencies (i.e. the first currency and the second currency) subject to the underlying transactions. Although each certificate represents a combination of an interest bearing short term investment and an exposure to changes in the yield curves of the two currencies, each certificate is designed to provide a different return profile for a particular anticipated set of future market conditions. Depending on the market conditions, currency pair and the certificate structure (i.e. short term investment maturity period, type of short term investment, etc.), these certificates can offer a variety of return profiles, from a return comparable to a standard short term investment to an un-leveraged or leveraged return dependent on the yield curve and yield curve differential of the two currencies involved in the certificate. Since the currencies and the fundamental certificate structure (i.e. maturity period, particular short term investment etc.) are known prior to purchasing the certificate, the client's selection of a particular certificate depends on the anticipated market conditions relative to the yield curve differential of the two currencies and thus, on the client's or advisor's view of the changes in the spread between the short term interest rates of the two currencies.

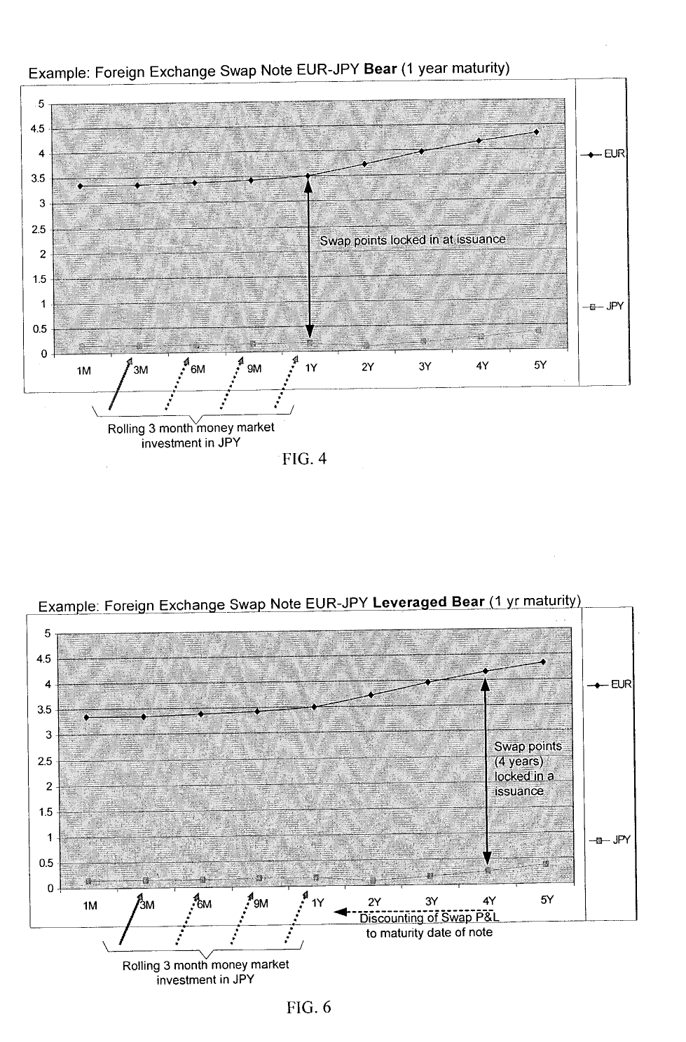

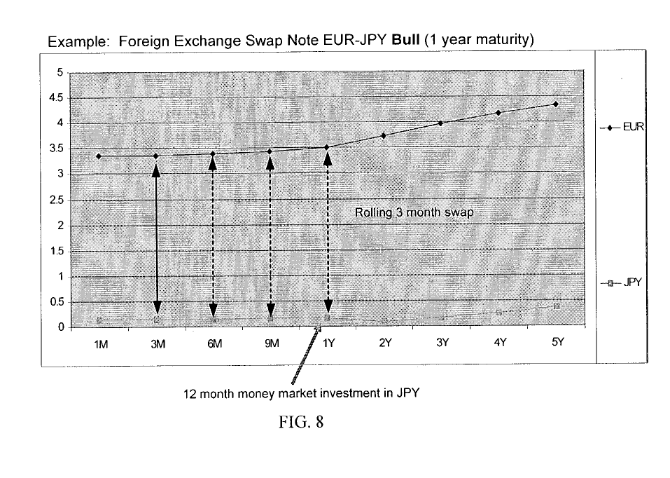

A brief overview of each certificate will now be provided followed by a detailed discussion of the underlying transactions with respect to each certificate relative to FIGS. 3-8. As previously stated, although the short term investment may be any short-term debt security, in the embodiments discussed in FIGS. 3-8, the short term investment is a money market investment and will be referred to using the “money market” description hereinafter. The Bear certificate is intended for clients who expect the short term interest rate differential between the first currency and the second currency to remain stable or preferably decrease during the lifetime (maturity period) of the certificate, e.g. one year. The Bear certificate generally permits the client to lock into a short term, e.g. one year, forward rate for the first currency via a foreign exchange swap while participating in the potential positive returns of a shorter term money market investment in the second currency which repeats until the maturity of the certificate, e.g. one year, as best shown in FIG. 4. Thus, the decrease in the interest rate differential between the first currency and the second currency, such as caused by an increase in the second currency interest rate during the lifetime of the certificate results in a positive return. The Leveraged Bear certificate is similar to the Bear certificate but is designed for clients who expect that the interest rate differential between the first currency and the second currency for a period, e.g. four years, longer than the maturity period of the certificate, e.g. one year, will remain stable or preferably decrease during the one year maturity period of the certificate, as shown in the example in FIG. 6. Thus, the Leveraged Bear permits the client to participate in a potential decrease in the interest rate differential over the yield curves for a longer period of time. That is, the interest rate spread is fixed for a time horizon greater than the maturity of the certificate, i.e. a four-year time horizon, thus providing leverage through a time effect. The Bull certificate, on the other hand, is designed for investors who expect the interest rate differential between the first currency and the second currency to remain stable or preferably increase during the lifetime of the certificate. As shown in FIG. 8, the Bull certificate generally permits the client to lock into the money market rate in the second currency for a period equivalent to the maturity period of the certificate, e.g. one year, while participating in a series of short term rolling foreign exchange swap transactions to potentially benefit from an increasing interest rate differential due to for example an increase in the first currency interest rate or a decrease in the second currency interest rate.

It should be noted that for all certificates the investor or client will receive cash flows based on the reference rates listed in the term sheets offering the certificates. However, many of the underlying transactions may be delayed by, for example, a day from the purchase date of the certificate. Therefore, these secondary market transactions may occur at hedging market rates which are different than the rates listed on the particular term sheet.

Referring to FIG. 3, the underlying transactions of the Bear certificate will now be described in more detail. The process begins with step 300 in which, in response to a client's request, the foreign exchange swap component of the Bear certificate is executed, by for example computer system 100, by conducting a spot transaction comprised of identifying a spot exchange rate and selling the principal amount of the certificate in the first currency for a second currency at the spot rate. The foreign exchange swap executing unit 118 determines the current spot rate by accessing the client's agreement/term sheet data provided to in central database 116. Alternatively, swap executing unit 118 may access a real-time spot and forward rates via foreign exchange rate data source 108. As noted above, the rates are preferably the mid rates published on the Reuters network for the particular reference exchange rates. Next, in step 302, foreign exchange swap executing unit 118 calculates a first forward rate based on a forward maturity period equal to the maturity period for the certificate or else forward foreign exchange market rates are used/accessed. It should be noted that the maturity period for each of the money market swap certificates provided in the examples herein is one year reflecting the short term nature and definition of the money market investment but another maturity period may be used, e.g. 6 months. The first forward rate is preferably calculated on the basis of the determined spot rate and the LIMEAN rate for the maturity period of the certificate, e.g. one year or else forward foreign exchange rates provided by the (inter-bank) market are used. The first forward rate is calculated using Equation I as follows:

$${F}_{T} = {F}_{Spot} \times \frac{1 + {r}_{1} {T}_{1}}{1 + {r}_{2} {T}_{2}}$$

where F_{T} is the foreign exchange rate at time T where T equals the future date of the forward transaction, i.e. maturity date of the certificate;

r₁ and r₂ are the interest rates of the second currency and the first currency, respectively;

and T₁ and T₂ are the time in years between the spot transaction and the future date of the forward transaction, e.g. one year.

In step 304, the principal amount in the second currency received from the spot transaction is invested in a selected money market investment having a money market maturity period less than the maturity period of the certificate. For example, preferably the maturity period of the money market investment is a period of months, e.g. three months, which can be rolled to create a series of money market investments, the last of which has the same maturity date as the certificate maturity date. The money market investment executing unit 120 may perform step 304. Next, in step 306, upon maturity of the selected money market investment, e.g. at the end of three months, a spot exchange rate is identified, by for example swap executing unit 118, and the money market investment interest earned on the three month money market investment in the second currency is exchanged for the first currency based on the spot exchange rate. In step 308, the exchanged interest in the first currency is paid out/delivered to the client. Of course, the interest may be paid out at a later time, e.g. quarterly. In step 310, the process determines whether the certificate has matured. If the end of the certificate maturity period has not been reached then the process returns to step 304 in which the principal amount in the second currency is reinvested in the selected money market investment and steps 306, 308 and 310 are again executed until the certificate maturity date. Once the maturity date of the certificate is reached, the process will move from step 310 to step 312 where the forward transaction identified in step 302 is executed. Specifically, an amount of the first currency is purchased against the principal amount of the money market investment in the second currency at the first forward rate calculated in step 302. That is, the principal amount of the money market investment in the second currency is exchanged into the first currency using the first forward rate. Next, in step 314, the certificate is settled with the client.

FIG. 4 graphically illustrates an example of the Bear certificate using the European Market euro (EUR) as the first currency and the Japanese yen (JPY) as the second currency. As can be seen from FIG. 4, while the principal amount of the certificate and the profit or loss of the swap transaction is not exposed to variations in the foreign exchange rate throughout the lifetime of the certificate, the interest payments on the money market investment are fully exposed to the exchange rate for the first and second currencies. The return on the Bear certificate is primarily determined by the swap points resulting out of the interest rate differential between the first currency and the second currency (graphically shown at certificate maturity in FIG. 4); the second currency interest rate of the rolling money market investment in the second currency; and the first currency/second currency exchange rate at which the second currency interest payments will be exchanged into the first currency at the end of each money market maturity period. In the situation where the second currency interest rates decrease thereby disadvantageously increasing the interest rate differential between the currencies, the interest owed may be accumulated and ultimately compensated with the redemption amount at the maturity of the certificate. The example of FIG. 4 illustrates the rolling three month money market investment where an increase in JPY interest rates after the purchase of the Bear certificate by the client may be realized at the six month, nine month and one year maturity dates of these rolling three month money market investments as the principal amount is reinvested in the money market investment. The client also experiences a positive return from the predefined interest rate differential between the first currency, i.e. EUR, and the second currency, i.e. JPY.

As a further example of the Bear certificate, assume the EUR/JPY spot rate is 116.36; and the money market rates are as follows: JPY LIMEAN three month rate equals 0.00188%; JPY LIMEAN one year rate equals 0.03438%; EUR LIMEAN one year rate equals 3.3375%. In this case, the corresponding forward rate for one year would equal 112.64. Assuming the original principal amount of the certificate is 1000 EUR, then if the EUR and JPY yield curves remain unchanged, the repayment amount including interest and after a management fee to the client during the lifetime of the certificate is 1023 EUR. On the other hand, if the JPY yield curve rises by 5%, then the repayment amount during the lifetime of the certificate including interest and after management fee is 1061 EUR. Lastly, if the JPY yield curve decreases by 0.5% (negative JPY interest rates), then the repayment amount after management fee and interest is 1019 EUR. This interest rate scenario of this example does not take into account changes in the foreign exchange rates which may occur and would affect the total return of the certificate. In FIG. 4, in economic terms, if JPY interest rates rise during the lifetime of the certificate to decrease the interest rate differential, a positive economic return occurs when the JPY money market investment is prolonged at higher JPY rates.

Thus, the Bear certificate is primarily advantageous for those investors or clients which anticipate the interest rate differential between the two subject currencies will decrease during the lifetime of the certificate. A client may seriously consider the Bear certificate where the second currency interest rates are perceived to be at a low point and expected to increase within the following year. Using the Bear certificate, the client could lock in the EUR/US interest rate differential for one year based on the first forward rate, that is lock in the swap points resulting out of the interest rate differential at the one year maturity date when the forward transaction is executed. If the second currency interest rates increase then the money market investment component of the certificate may become more beneficial. The rolling nature of the money market investment permits the client to take advantage of the increasing interest rates throughout the year. If the interest rates do not increase or only insignificantly increase, certain clients may benefit from the decomposition of the total return in a capital gain component and an interest income component.

The Bear certificate may alternatively be structured as a dual currency floating rate certificate. In this case, the certificate would likely be issued in the second currency and interest would be paid in the second currency on a floating rate basis. Upon issue, the repayment amount at certificate maturity is fixed in the first currency based on the forward rate.

In certain situations, perceived anticipated circumstances, for example political or economic events, relating to the country of the second currency may warrant an alternative hedging strategy for the Bear certificate to reduce the assets in the second currency. One alternative hedging strategy includes investing the first currency in the short term investment, e.g. one year, entering into a second currency interest rate swap, e.g., paying one year fixed while receiving a, for example, three month floating rate, and forward buying the second currency interest for the first currency to cover the foreign exchange risk on the second currency interest for the one year leg.

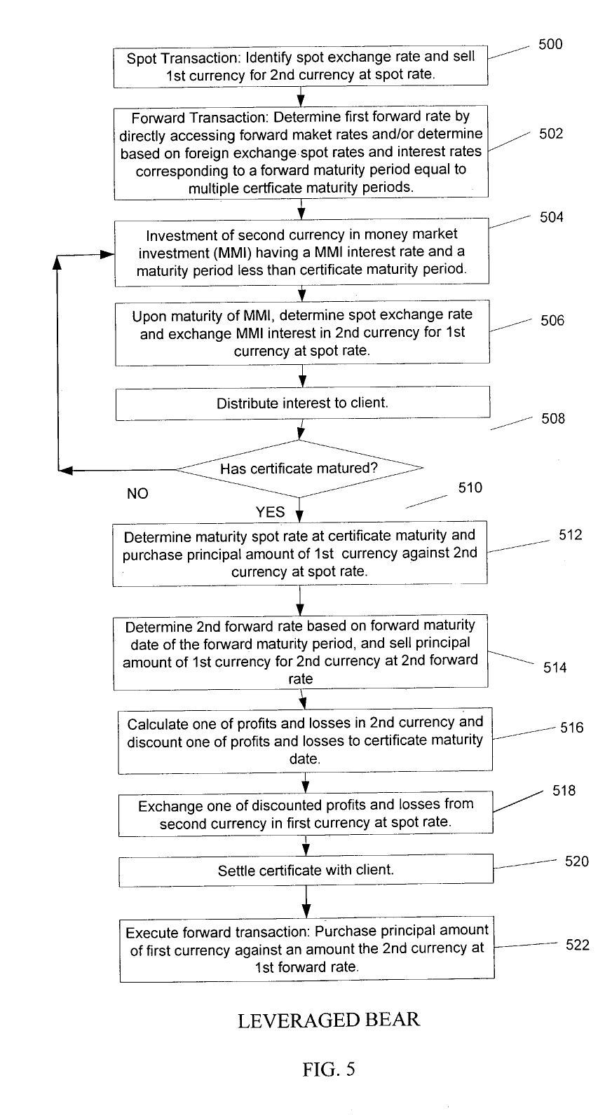

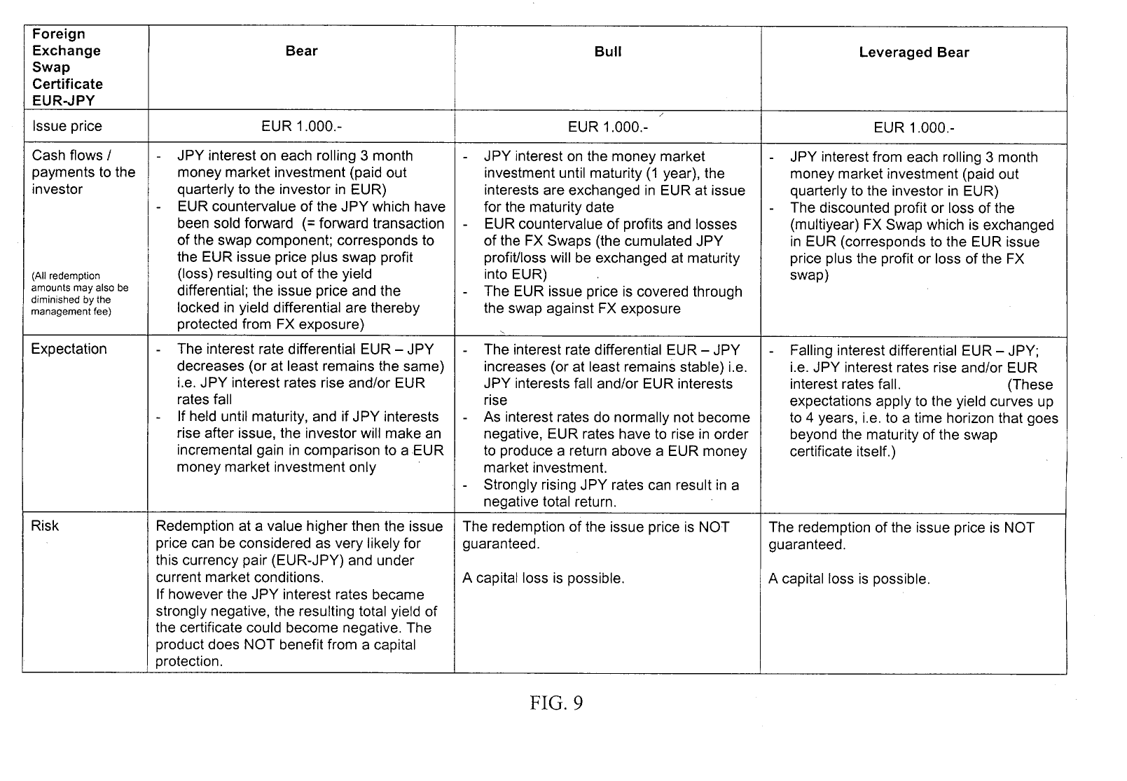

Referring now to FIG. 5, the underlying transactions of the Leveraged Bear certificate will now be described in further detail. The components of computer system 100 are used in a similar manner as that described above relative to the Bear certificate and will not be repeated in the description of the Leveraged Bear and Bull certificates except where new steps are performed. Similar to the Bear certificate, in step 400, a spot transaction is conducted which includes identifying a spot rate and selling the first currency for the second currency at the spot rate. Next, in step 502, the forward transaction portion of the swap component is determined by calculating a first forward rate associated with the forward maturity period or by directly accessing forward rates from a source providing market rates. With the Leveraged Bear certificate, the forward maturity period equal to multiple certificate maturity periods, e.g. two, three or four years. Next, in steps 504 through 510 are performed in the same manner as steps 304 through 310 of the Bear certificate of FIG. 3. However, in step 510, if the certificate maturity date has been reached, then the process moves to step 512 in which the maturity spot rate at certificate maturity is determined by, for example, foreign exchange swap executing unit 118, and the principal amount of the money market investment in the first currency is purchased against the second currency at the maturity spot rate. Then, in step 514, a second forward rate is determined by, for example, foreign exchange swap executing unit 118, based on interest rates related to the forward maturity date of the forward maturity period or by directly accessing forward rates from a source providing market rates. For example, assuming the certificate maturity period is one year and the forward maturity period is four years, then at certificate maturity, the second forward rate will be calculated based on swap interest rates (e.g. ISDA benchmark swap rates) for a 3 year period. The principal amount (i.e. the EUR 1000 in FIG. 9) in the first currency is then sold for the second currency at the second forward rate. The first forward rate in step 502 and a second forward rate in step 514 are both calculated using Equation II as follows:

$${F}_{T} = {F}_{Spot} \times \frac{{( 1 + {r}_{1} )}^{{T}_{2}}}{{( 1 + {r}_{2} )}^{{T}_{2}}}$$

where F_{T} is the forward rate;

r₁ and r₂ are the interest rates of the second currency and the first currency, respectively;

^{T}₁ and ^{T}₂ are time in years corresponding to the forward maturity period for the first forward rate (step 502) and corresponding to the time period between certificate maturity and the forward maturity date for the second forward rate.

Next, in step 516, after executing the forward transaction, any profits or losses in the second currency are calculated by, for example, profit and loss executing unit 516, and then discounted to the certificate maturity date. Then, in step 518, any discounted profits or losses in the second currency are exchanged into the first currency. In step 520, the certificate is settled with the customer. In step 522, the forward transaction is executed by purchasing the principal amount of the money market investment in the first currency against the second currency at the first forward rate calculated in step 502.

Thus, the Leveraged Bear certificate generally includes the swapping of the principal amount of the first currency for a second currency and investing the second currency resulting from the swap in a money market investment having a maturity period less than the maturity period of the certificate, such that the money market investment can be periodically rolled until the maturity of the certificate. Simultaneously, it is agreed that the first currency amount will be brought back again forward (forward transaction) at the forward maturity date of the forward maturity period. At maturity of the certificate, the principal amount of the first currency is bought against the second currency at a spot rate and simultaneously sold forward for the maturity of the original swap. The original swap transaction can then be closed by executing the forward transaction. The resulting swap profit or loss in the second currency (value-dated three years from maturity of the certificate) is discounted from the forward maturity date to the certificate maturity date and exchanged into the first currency.

Referring to FIG. 6, a particular example of the Leveraged Bear certificate will now be described. First, it is assumed that the maturity period of the certificate is one year, the forward maturity period of the swap component is four years, the first currency is EUR, the second currency is JPY and the issue price of the certificate is 1000 EUR. It is determined that the spot rate at issuance for EUR/JPY is 116.36. The JPY LIMEAN interest rate for a three month investment is 0.00188%; the JPY ISDA benchmark rate for four years is 0.20050%; and the EUR ISDA benchmark rate for four years is 4.21450%. Using these rates and equation 2, the corresponding forward rate for four years is 100.37. For purposes of this example, changes in the foreign exchange rates are not taken into account but such changes would affect the total return of the certificate. Any change in the value of JPY is expected to affect the return of the certificate in approximately the same proportions, e.g. an increase in JPY by 10% would increase the return on investment by the same proportion and vice versa. In a first scenario, the EUR and JPY yield curves remain unchanged resulting, during the lifetime of the certificate, in a repayment amount including interest and after management fee of 1022 EUR. However, if the EUR-JPY interest rate differential decreases by 5% over the entire yield curve (for example, the JPY rates rise by 5% and the interest rate differential becomes negative), then the corresponding repayment is 1171 EUR. On the other hand, if the EUR-JPY interest rate differential increases by 5% over the entire yield curve (for example, the EUR rates rise by 5%), then the corresponding repayment amount is 917 EUR. Thus, it can be seen from this example and the graph of FIG. 6 that the Leveraged Bear certificate results in a first currency cash flow at the end of the Leveraged time horizon, i.e. after the four year period, which will equal zero but a profit or loss in the second currency (JPY) will occur at the end of this forward maturity period. The profit or loss is fundamentally determined by the changes in the interest rate yield curves during the one year maturity period of the certificate. Furthermore, at maturity of the certificate, the discounted profit or loss which has been realized in the second currency is exchanged against the first currency. In the Bear certificate, the client can almost perfectly anticipate the profit out of the swap transaction component since the forward transaction is determined at the issuance of the certificate without any intermediate swap transactions of the principal amount. The Leveraged Bear certificate, on the other hand, includes an intermediate transaction at the end of the maturity period of the certificate for the principal amount of the first currency at a spot rate. The Leverage Bear certificate further includes simultaneously selling the same principal amount forward for the second currency, that is, three years forward to the end of the four year forward maturity period in the example described above. Thus, the second forward transaction and second forward rate is based on the interest rate differentials for the remaining three year period as the principal amount in the first currency is sold forward three years to permit closing of the original forward transaction at the first forward rate. The determination of that second forward rate will depend on the EUR and JPY interest rates determined at the one year maturity of the certificate and thus the change of the interest rates over the one year period of the certificate will impact the profit or loss in the second currency. This profit or loss is exposed to the foreign exchange rate changes as the principal amount is purchased based on the spot rate at certificate maturity. Because the cash flows occur in the first currency, if the second currency becomes stronger, then the profit or loss will be larger whereas if the second currency has fallen in value, the profit will be smaller or the loss will be less.

The total return on a Leveraged Bear certificate is primarily determined by the swap profits or losses resulting out of the interest rate differential between the first currency and the second currency for a period corresponding initially to a multiple of the maturity of the certificate, the second currency interest rate of the rolling money market investment, the exchange rate at which the discounted second currency profits or losses and the second currency interest payments are exchanged into the first currency, and the management fee charged by the issuer. Again, while the principal of the certificate is not exposed to foreign exchange rate risk, the interest payments as well as the swap profits and losses are fully exposed to variations in the exchange rate.

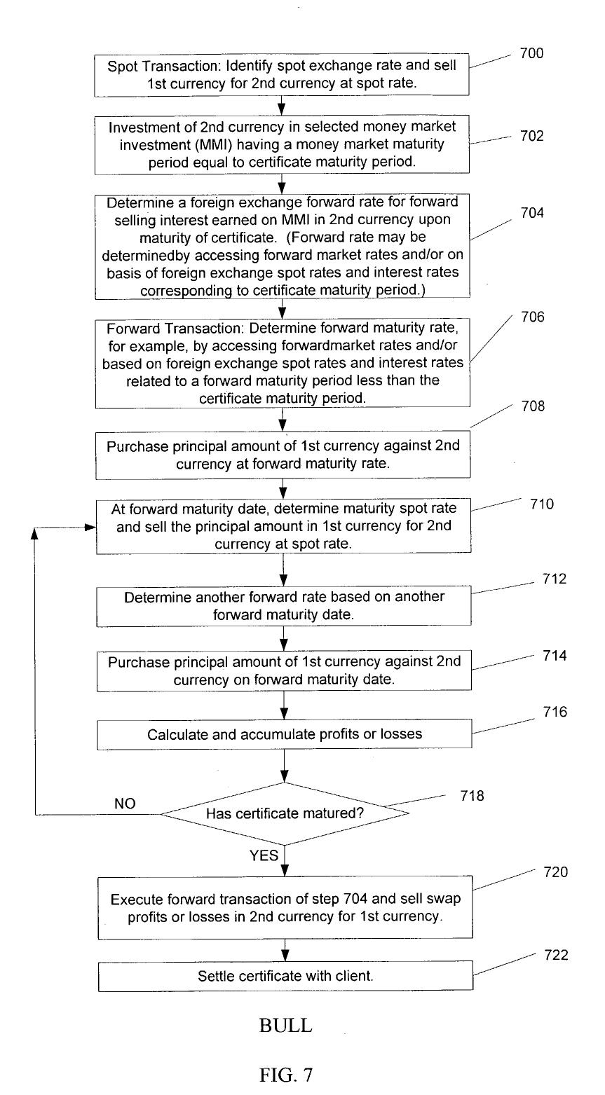

The details of the method for offering and executing the Bull certificate will now be discussed in further detail with respect to FIGS. 7 and 8. As shown in FIG. 7, once a client has requested the purchase of a Bull certificate and payment has been confirmed, a spot transaction is performed at the spot rate as shown in step 700 of FIG. 7 in the same manner as step 300 in the Bear certificate. Next, in step 702, the principal amount in the second currency is invested in the agreed upon money market investment having a money market maturity period or date equal to the certificate maturity period or date. In the Bull certificate, the client agrees that the interest earned on the money market investment in the second currency at the money market rate (i.e. LIMEAN one year) is sold forward into the first currency upon maturity of the certificate. In step 704, a foreign exchange forward rate is either determined using Equation I or the foreign exchange forward rates provided by a supplier of market rates are accessed.

In the Bull certificate, the forward transaction, associated with the swap component and the spot transaction of step 700, is an agreement to purchase the principal amount of the first currency against the second currency on the forward maturity date. In step 706, the first forward rate of the forward transaction of the swap component is calculated based on interest rates relating to the forward maturity date of the particular Bull certificate. Specifically, the forward rate is calculated using Equation I. Importantly, the forward maturity date or period is earlier than the certificate maturity date and preferably is a period which may be rolled to create a series of money market investments, the last of which matures on the same date as the certificate. It should be noted that steps 700-708 occur on the same day upon issuance of the certificate to the client. Next, in step 708, the principal amount of the money market investment in the first currency is purchased against the second currency at the first forward rate. In step 710, a maturity spot rate is determined by, for example, foreign exchange swap executing unit 122, and the principal amount in the first currency is sold for the second currency at the maturity spot rate. Then, in step 712, another forward rate is determined based on another forward maturity period, which is preferably identical to the first maturity period. Subsequently, on the next forward maturity date, the principal amount of the first currency is purchased against the second currency as shown in step 714. In step 716, the accumulated profits or losses from the swap component are calculated. Any interests on these swap profits or losses are neither paid out to the client nor charged. In step 718, the system queries whether the certificate has matured. If the certificate maturity date has not been reached, then the method reverts to step 710 in which another spot transaction including the determination of another maturity spot rate and the sale of the purchased principal amount in the first currency for the second currency at the new maturity spot rate. This rolling over effect is shown at three month intervals in the example represented in FIG. 8. Next, steps 712 and 714 are repeated. This rolling three month foreign exchange swap series permits the client to participate possibly in a rising interest rate differential between the first and second currencies. In step 718, if the certificate has indeed matured, then the process proceeds to step 720 where the forward transaction for the sale of the interest in the second currency (step 704) is executed at the predetermined foreign exchange forward rate. In step 722, the cumulated swap profits or losses in the second currency are sold at a spot rate for the first currency.

The return to the client on the Bull certificate is primarily determined by the swap points resulting out of the interest rate differential between the first currency and the second currency for the different sub-periods as shown graphically in the example of FIG. 8; the exchange rate at maturity at which the second currency swap profits and losses will be exchanged into the first currency; the second currency interest rate of the money market investment; and any management fee charged by the issuer. Again, while the principal of the certificate and the interest payment on the money market investment are not exposed to foreign exchange rate fluctuations/risk, the swap profits and losses associated with the rolling swap transactions are fully exposed to fluctuations in the currency exchange rate. Importantly, the profits or losses result from the forward transactions of the multiple swap components. The forward transactions are basically a hedge to the money market investment so that the combination of the money market investment and the four forward transactions, in the example shown in FIG. 8, results in no foreign exchange rate exposure of the original principal amount. Therefore, those investors that believe the interest rate differential between the primary currency and the secondary currency will increase, that is those investors that are bullish on the interest rate differential, would buy the Bull certificate.

As an example of the Bull certificate, assume the EUR/JPY spot rate is 116.36; and the money market rates are as follows: JPY LIMEAN three month rate equals 0.00188% and EUR LIMEAN three month rate equals 3.29225%. In this case, the corresponding forward rate for one year would equal 115.41. Assuming the original principal amount of the certificate is 1000 EUR, if the interest rate yield curves remain unchanged, then repayment at maturity and after management fee would be 1023 EUR. However, if the interest rate differential increases by 5% over the entire yield curve (EUR rates rise by 5%), then repayment at maturity would be 1059 EUR. On the other hand, if the interest rate differential decreases by 5% over the entire yield curve (JPY rates rise by 5% and the interest rate differential becomes negative), then repayment at maturity would be 986 EUR. Again, this example does not take into account changes in foreign exchange rates which would affect the total return of the note. Any change in the value of the JPY is expected to affect the return of the note in approximately the same proportions, e.g. an increase in JPY by 10% would increase the return on investment by the same proportion and vice versa. FIG. 9 shows a comparison of the cash flows, return expectations and risk for each certificate as applied to the EUR-JPY currency example discussed above.

Therefore, each of the financial instruments of the present invention, in the form of inventive foreign exchange swap certificates, provides a variety of return profiles. Each profile includes a varying degree of risk and a varying split between capital gains or losses and interest income, depending on the selected currencies and market conditions. Moreover, the three types of the inventive foreign exchange swap certificates provide an even greater number of possible return profiles. In addition, the unitized packaging of a diverse set of underlying transactions resulting from the unique combination of the foreign exchange swap component and the investment component into a single, tradable security in the form of the inventive certificate, provides a novel financial instrument that can be easily offered and executed in the marketplace.

It will thus be seen that the objects set forth above, among those made apparent from the preceding description, are efficiently attained and, since certain changes may be made, in carrying out the above processes, in a described instrument, and in the construction set forth, without departing from the spirit and scope of the invention, it is intended that all matter contained in the above description shown in the accompanying drawings shall be interpreted as illustrative and not in a limiting sense.

It is also to be understood that the following claims are intended to cover all of the generic and specific features of the invention herein described, and all statements of the scope of the invention, which, as a matter of language, might be said to fall therebetween.

I claim:

1. A method for offering and executing at least one foreign exchange swap certificate, comprising:
providing the at least one swap certificate for selection by a client, each of said at least one swap certificate having a foreign exchange swap component and an investment component; and
receiving a client's request to buy one of said at least one swap certificate for a principal amount in a first currency, and, in response to the client's request:
executing the foreign exchange swap component including conducting a spot transaction by selling the principal amount in the first currency for a second currency at a spot rate, and determining a forward transaction for exchanging the second currency for the first currency at a first forward rate based on a future date;
executing the investment component including investing the principal amount in the second currency resulting from the spot transaction in an investment; and
executing the forward transaction.

2. The method of claim 1, wherein said investment component is a short term investment, each of said at least one swap certificate further having a certificate maturity period.

3. The method of claim 2, wherein said at least one foreign exchange swap certificate includes a first swap certificate providing a positive total return to the client over the maturity period of the first swap certificate upon a decrease in an interest rate differential between an interest rate of the first currency and an interest rate of the second currency, and a second swap certificate providing a positive total return to the client over the maturity period upon an increase in said interest rate differential.

4. The method of claim 3, wherein said interest rates of the first and second currencies are money market interest rates.

5. The method of claim 2, wherein said forward transaction includes the steps of:
determining said first forward rate based on at least one of foreign exchange spot rates and interest rates corresponding to the certificate maturity period or by directly accessing foreign exchange forward rates provided by the market; and
purchasing an amount of the first currency at an end of the certificate maturity period corresponding to a forward value of the short term investment in the second currency at the first forward rate.

6. The method of claim 5, wherein the short term investment is a money market investment including a money market maturity period shorter than said certificate maturity period, the step of investing the second currency in a short term investment including the steps of:
determining a money market investment interest rate associated with the money market maturity period;
calculating a money market interest amount earned on the principal amount of the money market investment during the money market maturity period based on said money market investment interest rate;
determining a foreign exchange spot rate at the end of the money market maturity period;
exchanging said money market investment interest in said second currency for said first currency, based on said foreign exchange spot rate; and
delivering the money market investment interest in said first currency to the client.

7. The method of claim 6, further comprising the step of reinvesting said principal amount in said second currency in the money market investment for the money market maturity period and repeating the steps of claim 6, until the end of the certificate maturity period.

8. The method of claim 6, wherein the certificate maturity period is one year and the money market maturity period is three months.

9. The method of claim 2, wherein said forward transaction includes the steps of:
determining said first forward rate based on foreign exchange spot rates and interest rates or by directly accessing foreign exchange forward rates provided by a market source corresponding to a forward maturity period equal to multiple certificate maturity periods; and
purchasing the principal amount of the first currency against the second currency at an end of said forward maturity period at the first forward rate.

10. The method of claim 9, wherein said short term investment is a money market investment including a money market maturity period less than said certificate maturity period, said step of investing the second currency in a money market investment includes the steps of:
determining a money market investment interest rate associated with said money market maturity period;
calculating a money market interest amount earned on the principal amount of the money market investment during the money market maturity period based on said money market investment interest rate
determining a foreign exchange spot rate at the end of the money market maturity period;
exchanging said money market interest in said second currency for said first currency based on said foreign exchange spot rate; and
delivering the money market investment interest in said first currency to the client.

11. The method of claim 10, further comprising the steps of:
reinvesting said principal amount in said second currency in the money market investment and repeating the steps of claim 10 until the end of the certificate maturity period;
determining a maturity spot rate at the end of the certificate maturity period; and
purchasing the principal amount in said first currency against said second currency at said maturity spot rate.

12. The method of claim 11, further including the steps of determining a second forward rate upon maturity of said certificate, based on a forward maturity date equal to an end of said forward maturity period, for selling said principal amount in the first currency for the second currency, and selling the principal amount in the first currency for the second currency at said second forward rate.

13. The method of claim 12, further comprising the steps of:
calculating one of profits and losses in said second currency upon executing the forward transaction; and
discounting one of said profits and said losses to the certificate maturity date.

14. The method of claim 10, wherein the certificate maturity period is one year, the money market maturity period is three months, and the forward maturity period is one of two, three and four years.

15. The method of claim 2, wherein said short term investment includes a maturity period equal to said certificate maturity period.

16. The method of claim 15, wherein said forward transaction includes the steps of:
determining said first forward rate based on interest rates corresponding to a forward maturity period less than said certificate maturity period; and
purchasing the principal amount of the first currency against the short term investment in the second currency at an end of the forward maturity period.

17. The method of claim 16, further comprising the steps of:
determining a maturity spot rate at an end of the forward maturity period;
selling the purchased principal amount in said first currency for said second currency at said maturity spot rate;
determining another forward rate for another forward maturity period; and
purchasing the principal amount in the first currency against said second currency at an end of the another forward maturity period.

18. The method of claim 17, further including repeating the steps of claim 17 at the end of said another forward maturity period, until the end of the certificate maturity period.

19. The method of claim 15, further including the steps of:
determining a foreign exchange forward rate based on the certificate maturity period; and
forward selling an interest earned on said short term investment in said second currency at an end of the certificate maturity period.

20. The method of claim 15, wherein the certificate maturity period is one year and the forward maturity period is three months.

21. A computer implemented system for providing and executing at least one foreign exchange swap certificate, comprising:
communications managing unit adapted to manage electronic communications relating to a purchase of at least one swap certificate by a client from a certificate issuer for a principal amount in a first currency, said at least one swap certificate having a foreign exchange swap component and an investment component;
swap execution unit adapted to execute the foreign exchange swap component in response to an electronic communication from said means for managing electronic communications, said swap execution unit adapted to conduct a spot transaction by selling the principal amount in the first currency for a second currency at a spot rate, determine a first forward rate based on a future forward transaction date for exchanging the second currency for the first currency at a first forward rate, and execute the forward transaction; and
investment execution unit adapted to execute the investment component by investing the principal amount in the second currency resulting from the spot transaction in an investment.

22. The system of claim 21, wherein said investment component is a short term investment, each of said at least one swap certificate further having a certificate maturity period.

23. The system of claim 22, wherein said at least one foreign exchange swap certificate includes a first swap certificate tending to provide a positive total return to the client over the maturity period of the first swap certificate upon a decrease in an interest rate differential between an interest rate of the first currency and an interest rate of the second currency, and a second certificate providing a positive total return to the client over the certificate maturity period upon an increase in said interest rate differential.

24. The system of claim 23, wherein said interest rates of the first and second currencies are money market interest rates.

25. The system of claim 22, wherein said swap execution unit is adapted to determine said first forward rate based on foreign exchange spot rates and interest rates related to the certificate maturity period or by directly accessing forward foreign exchange market rates, and to purchase an amount of the first currency at an end of the certificate maturity period corresponding to a forward value of the short term investment in the second currency at the first forward rate.

26. The system of claim 25, wherein short term investment is a money market investment including a money market maturity period shorter than said certificate maturity period, said investment execution unit being adapted to determine a money market investment interest rate associated with said money market maturity period, calculate a money market interest amount earned on the principal amount of the money market investment during the money market maturity period based on said money market investment interest rate, determine a foreign exchange spot rate at the end of the money market maturity period, determining an foreign exchange spot rate, exchange said money market investment interest in said second currency for said first currency based on said foreign exchange spot rate, and reinvest said principal amount in the money market investment for the money market maturity period.

27. The system of claim 26, wherein said investment execution unit is adapted to reinvest the principal amount in said second currency in the money market investment and to repeat the functions of claim 26 through the end of the certificate maturity period.

28. The system of claim 26, wherein the certificate maturity period is one year and the money market maturity period is three months.

29. The system of claim 22, wherein said swap execution unit is adapted to determine said first forward rate based on foreign exchange spot rates and interest rates, or by directly accessing forward foreign exchange market rates, corresponding to a forward maturity period equal to multiple certificate maturity periods and purchase the principal amount of the first currency against the second currency at an end of said forward maturity period at the firsf forward rate.

30. The system of claim 29, wherein said short term investment is a money market investment including a money market maturity period shorter than said certificate maturity period, said investment execution unit being adapted to determine a money market investment interest rate associated with said money market maturity period, calculate a money market interest amount earned on the principal amount of the money market investment during the money market maturity period based on said money market investment interest rate, determine a foreign exchange spot rate at the end of the money market maturity period, exchange said money market interest in said second currency for said first currency based on said foreign exchange spot rate for payment to the client, and reinvest said principal amount in the money market investment.

31. The system of claim 30, wherein said investment execution unit is adapted to repeat the functions of claim 30 through the end of the certificate maturity period, said swap execution unit further adapted to determine a maturity spot rate at the end of the certificate maturity period and purchase the principal amount of said money market investment in said first currency against said second currency at said maturity spot rate.

32. The system of claim 31, wherein said swap execution unit is further adapted to determine a second forward rate upon maturity of said certificate based on a forward date equal to the end of said forward maturity period for selling said principal amount in the first currency for the second currency, and sell the principal amount in the first currency for the second currency at said second forward rate.

33. The system of claim 29, further including for a profit and loss execution unit adapted to calculate one of profits and losses in said second currency upon executing the forward transaction and discount one of said profits and losses to the certificate maturity date.

34. The system of claim 29, wherein the certificate maturity period is one year, the money market maturity period is three months and the forward maturity period is one of two, three and four years.

35. The system of claim 22, wherein said short term investment includes a maturity period equal to said certificate maturity period.

36. The system of claim 35, wherein said money market investment includes a forward maturity period less than said certificate maturity period, said swap execution unit being adapted to determine the first forward rate based on foreign exchange spot rates and interest rates corresponding to the forward maturity period or by directly accessing forward foreign exchange market rates, and purchase the principal amount of the first currency against the short term investment in the second currency at the end of the forward maturity period.

37. The system of claim 36, wherein said swap execution unit is further adapted to determine a maturity spot rate, sell the purchased principal amount in said first currency for said second currency at said maturity spot rate, determine another forward rate for another forward maturity period, and purchase the principal amount of the money market investment in the first currency against said second currency at an end of the another forward maturity period.

38. The system of claim 37, wherein said swap execution unit is adapted to repeat the functions of claim 37 at an end of the another forward maturity period, until the end of the certificate maturity period.

39. The system of claim 36, wherein said swap execution unit is further adapted to determine a foreign exchange forward rate based on the certificate maturity period and forward sell an interest earned on said short term investment in said second currency at an end of the certificate maturity period.

40. A method for executing a financial instrument having a foreign exchange swap component and an investment component, said method comprising:
executing the foreign exchange swap component including conducting a spot transaction by selling a principal amount in a first currency for a second currency at a spot rate, and determining a forward transaction for exchanging the second currency for the first currency at a first forward rate based on a future date;
executing an investment component including investing the principal amount in the second currency resulting from the spot transaction in an investment; and
executing the forward transaction.

41. The method of claim 40, wherein said financial instrument tends to provide a positive total return over a maturity period of the instrument upon a decrease in an interest rate differential between an interest rate of the first currency and an interest rate of the second currency.

42. The method of claim 40, wherein said financial instrument tends to provide a positive total return over a maturity period of the instrument upon an increase in an interest rate differential between an interest rate of the first currency and an interest rate of the second currency.

43. The method of claim 40, wherein said investment component is a short term investment.

44. The method of claim 43, wherein said forward transaction includes determining said first forward rate based on foreign exchange spot rates and interest rates corresponding to an instrument maturity period or by directly accessing forward foreign exchange market rates,, and purchasing an amount of the first currency at an end of the instrument maturity period corresponding to the short term investment in the second currency at the first forward rate.

45. The method of claim 44, wherein the short term investment is a money market investment including a money market maturity period shorter than said instrument maturity period, the step of investing the second currency in a short term investment including the steps of determining a money market investment interest rate associated with the money market maturity period, calculating a money market interest amount earned on the principal amount of the money market investment during the money market maturity period based on said money market investment interest rate, determining a foreign exchange spot rate at the end of the money market maturity period and exchanging said money market investment interest in said second currency for said first currency based on said foreign exchange spot rate.

46. The method of claim 45, further comprising the step of reinvesting said principal amount in said second currency in the money market investment for the money market maturity period and repeating the steps of claim 45, until the end of the instrument maturity period.

47. The method of claim 45, wherein the instrument maturity period is one year and the money market maturity period is three months.

48. The method of claim 43, wherein said forward transaction includes determining said first forward rate based on foreign exchange spot rates and interest rates or by directly accessing forward foreign exchange market rates, corresponding to a forward maturity period equal to multiple instrument maturity periods and purchasing the principal amount of the first currency against the second currency at an end of the forward maturity period at the first forward rate.

49. The method of claim 48, wherein said short term investment is a money market investment including a money market maturity period less than said instrument maturity period, said step of investing the second currency in a money market investment includes the steps of determining a money market investment interest rate associated with said money market maturity period, calculating a money market interest amount earned on the principal amount of the money market investment during the money market maturity period based on said money market investment interest rate, determining a foreign exchange spot rate at the end of the money market maturity period and exchanging said money market interest in said second currency for said first currency based on said foreign exchange spot rate.

50. The method of claim 49, further comprising the step of reinvesting said principal amount in said second currency in the money market investment and repeating the steps of claim 49 through the end of the instrument maturity period, further including the steps of determining a maturity spot rate at the end of the instrument maturity period and purchasing the principal amount in said first currency against said second currency at said maturity spot rate.

51. The method of claim 50, further including the steps of determining a second forward rate upon maturity of the instrument based on a forward maturity date equal to an end of said forward maturity period for selling said principal amount in the first currency for the second currency, and selling the principal amount in the first currency for the second currency at said second forward rate.

52. The method of claim 51, further comprising the steps of calculating one of profits and losses in said second currency upon executing the forward transaction and discounting one of said profits and said losses to the instrument maturity date.

53. The method of claim 49, wherein the instrument maturity period is one year, the money market maturity period is three months and the forward maturity period is one of two, three and four years.

54. The method of claim 43, wherein said short term investment includes a maturity period equal to an instrument maturity period.

55. The method of claim 54, wherein said forward transaction includes determining said first forward rate based on foreign exchange spot and interest rates or by directly accessing forward foreign exchange market rates, corresponding to a forward maturity period less than said instrument maturity period and purchasing the principal amount of the first currency against the short term investment in said second currency at an end of the forward maturity period.

56. The method of claim 55, further comprising the steps of determining a maturity spot rate at an end of the forward maturity period, selling the purchased principal amount in said first currency for said second currency at said maturity spot rate, determining another forward rate for another forward maturity period, and purchasing the principal amount in the first currency against said second currency at an end of the another forward maturity period.

57. The method of claim 56, further including repeating the steps of claim 56 at the end of the another forward maturity period, until the end of the instrument maturity period.

58. The method of claim 54, further including the step of determining a foreign exchange forward rate based on the instrument maturity period and forward selling an interest earned on said short term investment in said second currency at an end of the instrument maturity period.

59. The method of claim 54, wherein the instrument maturity period is one year and the forward maturity period is three months.

60. A financial instrument representing a single security with plural components and having an instrument maturity period, said instrument comprising:
at least one foreign exchange swap component having a principal amount in a first currency, a spot transaction amount in a second currency resulting from a spot transaction of the first currency against the second currency at a spot rate, and a forward transaction amount determined by an exchange of the second currency for the first currency at a first forward rate; and
at least one investment component having an initial investment amount, an interest rate and an investment maturity period, wherein the initial investment amount is the spot transaction amount in the second currency resulting from the spot transaction.

61. The instrument of claim 60, wherein said at least one investment component is a short term investment component.

62. The instrument of claim 61, wherein the combination of said foreign exchange swap component and said short term investment component tends to provide a positive total return over the instrument maturity period upon a decrease in an interest rate differential between an interest rate of the first currency and an interest rate of the second currency.

63. The instrument of claim 61, wherein the combination of said foreign exchange swap component and said short term investment component tends to provide a positive total return over the instrument maturity period upon a increase in an interest rate differential between an interest rate of the first currency and an interest rate of the second currency.

64. The instrument of claim 61, wherein said first forward rate is determined based on the instrument maturity period.

65. The instrument of claim 61, wherein the short term investment includes an investment maturity period shorter than the instrument maturity period.

66. The instrument of claim 65, wherein the instrument maturity period is one year and the investment maturity period is three months.

67. The instrument of claim 61, wherein said first forward rate is based on foreign exchange spot rates and on interest rates or on directly accessed foreign exchange forward rates provided by a market source, corresponding to a forward maturity period equal to multiple instrument maturity periods.

68. The instrument of claim 67, wherein the instrument maturity period is one year, the investment maturity period is three months and the forward maturity period is one of two, three and four years.

69. The instrument of claim 61, wherein said investment maturity period is equal to the instrument maturity period.

70. A computer readable medium having instructions for effecting a financial instrument, said medium comprising:
instructions for executing a foreign exchange swap component of the instrument including conducting a spot transaction by selling a principal amount in a first currency for a second currency at a spot rate and executing a forward transaction including determining a first forward rate for exchanging the second currency for the first currency at the first forward rate; and
instructions for executing an investment component of the instrument by investing the principal amount in the second currency resulting from the spot transaction in a short term investment.

71. The medium of claim 70, wherein said investment component is a short term investment, said financial instrument having an instrument maturity period.

72. The medium of claim 71, wherein said instructions for executing the foreign exchange swap component includes instructions for determining said first forward rate based on foreign exchange swap and interest rates or by directly accessing foreign exchange forward rates provided by a market source, related to the instrument maturity period, and purchasing an amount of the first currency at an end of the instrument maturity period corresponding to a forward value of the short term investment in the second currency at the first forward rate.

73. The medium of claim 72, wherein said short term investment is a money market investment including a money market maturity period shorter than the instrument maturity period, said instructions for executing the money market investment component including instructions for determining a money market investment interest rate associated with said money market maturity period, calculating a money market interest amount earned on the principal amount of the money market investment during the money market maturity period based on said money market investment interest rate, determining a foreign exchange spot rate at the end of the money market maturity period, exchanging said money market investment interest in said second currency for said first currency based on said foreign exchange spot rate, and reinvesting said principal amount in the money market investment for the money market maturity period.

74. The medium of claim 73, wherein said instructions for executing the money market investment component includes instructions reinvesting said principal amount in said second currency in the money market investment for the money market maturity period and for repeating the functions of claim 73 through the end of the instrument maturity period.

75. The medium of claim 71, wherein said instructions for executing the foreign exchange swap component includes instructions for determining said first forward rate based on foreign exchange spot rates and on interest rates or by directly accessing foreign exchange forward rates provided by a market source, corresponding to a forward maturity period equal to multiple instrument maturity periods and purchasing the principal amount of the first currency against the second currency at an end of the investment maturity period at first forward rate.

76. The medium of claim 75, wherein said short term investment is a money market investment including a money market maturity period shorter than the instrument maturity period, said instructions for executing the money market investment component including instructions for determining a money market investment interest rate associated with said money market maturity period, calculating a money market interest amount earned on the principal amount of the money market investment during the money market maturity period based on said money market investment interest rate, determining a foreign exchange spot rate at the end of the money market maturity period, exchanging said money market interest in said second currency for said first currency based on said foreign exchange spot rate, and reinvesting said principal amount in the money market investment.

77. The medium of claim 76, wherein said instructions for executing the money market investment component includes instructions for repeating the functions of claim 76 through the end of the instrument maturity period, said means for executing the foreign exchange swap means further functioning for determining a maturity spot rate at the end of the instrument maturity period and purchasing the principal amount of said money market investment in said first currency against said second currency at said maturity spot rate.

78. The medium of claim 77, wherein said instructions for executing the foreign exchange swap component includes instructions for determining a second forward rate upon maturity of the instrument based on a forward date equal to the end of said forward maturity period for selling said principal amount in the first currency for the second currency, and selling the principal amount in the first currency for the second currency at said second forward rate.

79. The medium of claim 75, further including means for calculating one of profits and losses in said second currency upon executing the forward transaction and discounting one of said profits and losses to the instrument maturity date.

80. The medium of claim 75, wherein the instrument maturity period is one year, the money market maturity period is three months and the forward maturity period is one of two, three and four years.

81. The medium of claim 71, wherein said short term investment includes a forward maturity period less than the instrument maturity period, said instructions for executing the foreign exchange swap component including instructions for determining the first forward rate based on foreign exchange spot rates and on interest rates or by directly accessing foreign exchange forward rates provided by a market source, corresponding to the forward maturity period and purchasing the principal amount in the first currency against the short term investment in said second currency at the end of the forward maturity period.

82. The medium of claim 81, wherein said instructions for executing the foreign exchange swap component includes instructions for determining a spot rate, selling the purchased principal amount in said first currency for said second currency at said maturity spot rate, determining another forward rate for another forward maturity period, and purchasing the principal amount of the first currency against said second currency at an end of the another forward maturity period.

83. The medium of claim 82, wherein said instructions for executing the foreign exchange swap component includes instructions for repeating the functions of claim 82 at an end of the another forward maturity period, until the end of the instrument maturity period.

84. The medium of claim 81, wherein said instructions for executing the foreign exchange swap component includes instructions for determining a foreign exchange forward rate based on the instrument maturity period and forward selling an interest earned on said short term investment in said second currency at an end of the instrument maturity period.
